(19) United States
(12) Patent Application Publication
(10) Pub. No.: US 2022/0289241 A1
(43) Pub. Date: Sep. 15, 2022

(54) METHOD AND DEVICE FOR OPERATING AN AUTOMATED VEHICLE

(71) Applicant: Robert Bosch GmbH, Stuttgart (DE)

(72) Inventors: Jan Rohde, Stuttgart (DE); Philipp Rasp, Wannweil (DE)

(21) Appl. No.: 17/639,689

(22) PCT Filed: Jul. 10, 2020
(86) PCT No.: PCT/EP2020/069553

§ 371 Date: May 5, 2022

(30) Foreign Application Priority Data
Sep. 6, 2019 (DE) 10 2019 213 612.5

(51) Int. Cl. B60W 60/00; G01C 21/00

(52) U.S. Cl. CPC B60W 60/0015; G01C 21/3848; B60W 2556/45; B60W 2420/00

(57) ABSTRACT

A method and a device for operating an automated vehicle. The method includes a step of determining a rough position, a step of detecting an operating state of the automated vehicle, a step of checking whether it is possible, proceeding from the rough position, to determine a precise position as a function of the operating state, a step of determining the precise position when it is possible to determine the precise position, or a step of providing a signal, which represents a non-determination of the precise position, when it is not possible to determine the precise position, and a step of operating the vehicle as a function of the precise position or as a function of the signal.

### FIELD

The present invention relates, among other things, to a method for operating an automated vehicle, as a function of the precise position or as a function of a signal which represents a non-determination of this precise position.

### SUMMARY

A method according to an example embodiment of the present invention for operating an automated vehicle includes a step of determining a rough position, a step of detecting an operating state of the automated vehicle, and a step of checking whether, proceeding from the rough position, it is possible to determine a precise position as a function of the operating state. The method furthermore includes a step of determining the precise position when it is possible to determine the precise position, or a step of providing a signal, which represents a non-determination of the precise position, when it is not possible to determine the precise position, and a step of operating the vehicle, as a function of the precise position or as a function of the signal.

An automated vehicle shall be understood to mean a vehicle which is designed according to one of SAE Levels 1 through 5 (see standard SAE J3016).

A rough position shall be understood to mean a position which has a certain lack of definition. This lack of definition is several meters, for example, and may range up to several hundred meters, depending on the surroundings of the automated vehicle (tall buildings, tunnel, etc.). In one specific embodiment, a rough position shall, in particular, be understood to mean a position which is so imprecise that the automated vehicle cannot be operated in an automated manner (according to one of SAE Levels 1 through 5) even though this is intended and/or, for example, desired by an occupant of the automated vehicle.

A precise position shall be understood to mean a position which is so precise within a predefined coordinate system, for example WGS84 coordinates, that this position does not exceed a maximum permissible lack of definition. The maximum lack of definition may, for example, depend on the surroundings. Furthermore, the maximum lack of definition may, for example, depend on whether the automated vehicle is operated manually or in a semi-automated, highly automated or fully automated manner (corresponding to one of the SAE Levels 1 through 5). In principle, the maximum lack of definition is so low that, in particular, a safe operation of the automated vehicle is ensured. For a fully automated operation of an automated vehicle, the maximum lack of definition is in a range of approximately 10 centimeters, for example.

An operating state of the automated vehicle shall, for example, be understood to mean an automation level (according to one of the SAE Levels 1 through 5) of the automated vehicle and/or an instantaneous speed of the automated vehicle and/or an instantaneous lateral and/or longitudinal acceleration and/or an activated or deactivated driving function (such as, for example, an (adaptive) cruise control system, etc.) and/or a lighting control state (high or low beam, etc.) and/or further driver assistance or AD functions. A detection of the operating state shall, for example, be understood to mean the reading out of one or multiple control unit(s) which provide a corresponding signal (for example, high beam is activated).

An operation of the automated vehicle shall, for example, be understood to mean the execution of safety-relevant functions (“readying” or triggering an air bag, tightening a seat belt, carrying out an emergency-related stopping process, etc.) and/or the execution of so-called driver assistance functions (here, for example: executing a lane-keeping assistant, etc.) and/or an automated lateral and/or longitudinal control and/or a determination and/or following of a trajectory for the automated vehicle.

The method according to an example embodiment of the present invention advantageously achieves the object of providing a method for operating a vehicle. This object is achieved with the aid of the method according to the present invention in that the vehicle is operated as a function of the precise position or as a function of the signal, it being checked in advance whether it is possible to determine a precise position, proceeding from the rough position and as a function of the operating state. This yields the advantage that both the time and computing effort are reduced since, for example, proceeding from the rough position, a relatively small area has to be checked, and the determination of the precise position (if possible) is carried out accordingly more quickly (since it is situated within the area of the rough position). Furthermore, the precise position is only determined as precisely as is necessary as a function of the operating state. This also results in a faster and more efficient determination of the precise position. The method thus overall reduces the consumption of resources for determining the precise position and allows the automated vehicle to be operated more safely since the corresponding pieces of information are available more quickly. Another advantage of the method according to the present invention is an improved ability to assess the so-called “map matching performance.” Parameters (such as, e.g., limiting values for similarity metrics) may be statistically determined from the fleet data present on the cloud site and may be applied.

The determination of the rough position preferably takes place with the aid of a surroundings sensor system and/or with the aid of a positioning system.

A surroundings sensor system shall be understood to mean at least one video sensor and/or at least one radar sensor and/or at least one LIDAR sensor and/or at least one ultrasonic sensor and/or at least one further sensor, which is designed to detect surroundings of an (automated) vehicle, the surroundings, in particular, encompassing localization features, in the form of surroundings data values. A localization feature shall, for example, be understood to mean an object (traffic signs, infrastructure features [guard rail, curve profile, tunnels, bridges, etc.], buildings, etc.), which may be detected and/or classified or assigned with the aid of a surroundings sensor system of a vehicle. In one specific embodiment, the surroundings sensor system includes, for example, a processing unit (processor, working memory, hard disk) including suitable software and/or is connected to such a processing unit for this purpose. In one specific embodiment, a localization feature shall, additionally or alternatively, be understood to mean, for example, a road profile (number of lanes, curve radius, etc.) and/or a pattern of multiple—for example recurring—objects (for example, a characteristic sequence of traffic signs, etc.).

A positioning system shall, for example, be understood to mean a global navigation satellite system (GNSS), this system being designed for position determination and navigation on the earth and/or in the air, by receiving signals from navigation satellites and pseudolites.

The determination of the rough position preferably takes place relative to a first map.

A determination of the rough position with the aid of a surroundings sensor system shall, for example, be understood to mean that localization features (for example, signs including street or city names) detected with the aid of the surroundings sensor system are compared to a map which encompasses the corresponding localization features (see above: the corresponding street and/or city names; characteristic buildings, etc.). In one specific embodiment, the map corresponds to the first map, a first map being understood to mean a digital map which is present in the form of (map) data values on a storage medium. For example, the map is designed in such a way that one or multiple map layer(s) is/are encompassed, a map layer showing a map from a bird's eye view (course and position of roads, buildings, landscape features, etc.), for example. This corresponds to a map of a navigation system, for example. Another map layer encompasses a radar map, for example, the localization features encompassed by the radar map being stored together with a radar signature. Another map layer encompasses a LIDAR map, for example, the localization features encompassed by the LIDAR map being stored together with a LIDAR signature. The map is, in particular, designed in such a way that it is suitable for navigating a vehicle, in particular, an automated vehicle.

A determination of the rough position relative to the first map shall, for example, be understood to mean a mapping of the rough position in the first map, this position being determined, for example, with a lack of definition in the form of a coverage of an area.

In one specific embodiment of the present invention, the determination of the rough position takes place with the aid of a surroundings sensor system and with the aid of a positioning system in that, for example, a first rough position is determined with the aid of the positioning system, and thereafter is subjected to a plausibility check with the aid of detected localization features (for example, with the aid of a comparison of a background color of traffic signs when the first rough position—relative to the first map—suggests a negotiation of an expressway, etc.). Thereafter, the first rough position is considered to have been determined as a rough position when the plausibility check is successful.

The operating state preferably encompasses a predefined safety requirement, the determination of the precise position taking place as a function of the predefined safety requirement.

A predefined safety requirement shall, for example, be understood to mean a specification of a maximum lack of definition of a position determination. In the process, the safety requirement is provided, for example, as a signal (during the activation of a corresponding function, etc.).

The determination of the precise position preferably takes place with the aid of a second map, the second map being selected as a function of the rough position and/or as a function of the operating state.

A second map shall, for example, be understood to mean a sub-section of the first map, only this sub-section being used for determining the precise position. In one specific embodiment, the second map shall be understood to mean a map which is independent of the first map. The second map is, in particular, designed in such a way that it is suitable for navigating an automated vehicle. For this purpose, the individual map layers encompass, for example, localization features having a GPS position, this position being precisely known (within the meaning of an above-mentioned precise position).

A device according to an example embodiment of the present invention is configured to carry out all steps of the method(s) disclosed herein for operating an automated vehicle.

In accordance with an example embodiment of the present invention, the device is designed as a control unit of the automated vehicle, for example, and includes a processing unit (processor, working memory, hard disk) as well as suitable software for carrying out the method as disclosed herein. In one specific embodiment, the device includes a transceiver unit, which is designed to exchange data values, in particular, with an external server or a cloud. In one further specific embodiment, the device, for example additionally or alternatively, includes a data interface to exchange data values with a transceiver unit of the automated vehicle.

In one alternative specific embodiment of the present invention, the device is, for example, designed as an externally situated processing unit (server, cloud, etc.), relative to the automated vehicle. In the process, the determination of the rough position takes place, for example, in that localization features detected with the aid of a surroundings sensor system of the automated vehicle are received by this automated vehicle and compared to a map which encompasses the corresponding localization features.

The detection of the operating state of the automated vehicle takes place, for example, in that the operating state is received as data values from the automated vehicle. An operation of the automated vehicle here, for example, shall be understood to mean the provision of a signal in such a way that the automated vehicle is able to retrieve and/or receive this signal from the device, the signal encompassing or representing a rule for operating the automated vehicle.

Furthermore, a computer program is provided, encompassing commands which, during the execution of the computer program by a computer, prompt the computer to carry out a method disclosed herein for operating an automated vehicle. In one specific example embodiment of the present invention, the computer program corresponds to the software encompassed by the device.

Moreover, a machine-readable memory medium is provided, on which the computer program is stored.

Advantageous refinements of the present invention are disclosed herein.

### BRIEF DESCRIPTION OF THE DRAWINGS

Exemplary embodiments of the present invention are shown in the figure and are described in greater detail in the following description.

FIG. 1 shows one exemplary embodiment of the method according to the present invention for operating a vehicle in the form of a flowchart.

### DETAILED DESCRIPTION OF EXAMPLE EMBODIMENTS

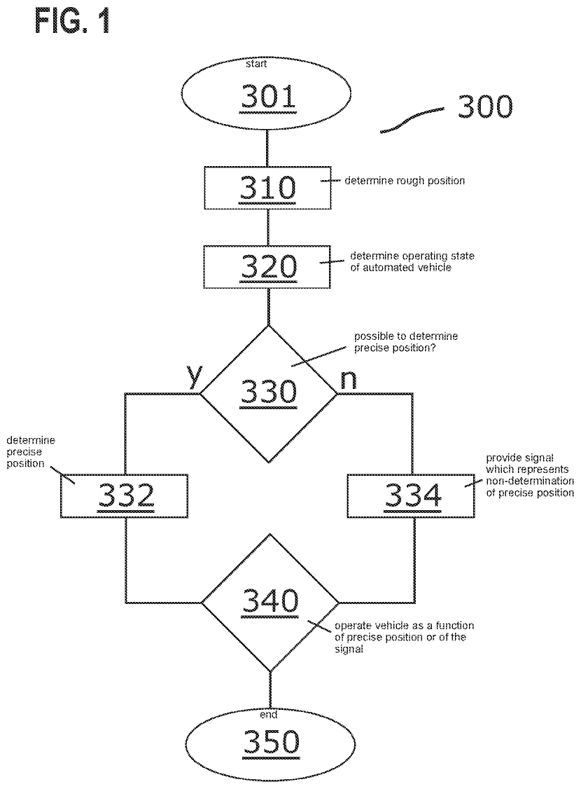

FIG. 1 shows one exemplary embodiment of a method 300 for operating 340 an automated vehicle.

In step 301, method 300 starts.

In step 310, a rough position is determined.

In step 320, an operating state of the automated vehicle is detected.

In step 330, it is checked whether, proceeding from the rough position, it is possible to determine a precise position as a function of the operating state. Thereafter, step 332 follows when it is possible to determine the precise position, or step 334 follows when it is not possible to determine the precise position.

In step 332, the precise position is determined.

In step 334, a signal, which represents a non-determination of the precise position, is provided.

In step 340, the vehicle is operated as a function of the precise position or as a function of the signal.

In step 350, method 300 ends.

1-8. (canceled)

9. A method for operating an automated vehicle, comprising:
determining a rough position;
detecting an operating state of the automated vehicle;
checking whether it is possible, proceeding from the rough position, to determine a precise position as a function of the operating state; and
determining the precise position when it is possible to determine the precise position, or providing a signal, which represents a non-determination of the precise position, when it is not possible to determine the precise position; and
operating the vehicle, as a function of the precise position or as a function of the signal.

10. The method as recited in claim 9, wherein the determination of the rough position takes place using a surroundings sensor system and/or using a positioning system.

11. The method as recited in claim 9, wherein the determination of the rough position takes place relative to a first map.

12. The method as recited in claim 11, wherein the operating state encompasses a predefined safety requirement, the checking as to whether it is possible to determine a precise position taking place as a function of the predefined safety requirement.

13. The method as recited in claim 9, wherein the determination of the precise position takes place using a second map, the second map being selected as a function of the rough position and/or as a function of the operating state.

14. A device configured to operate an automated vehicle, the device configured to:
determine a rough position;
detect an operating state of the automated vehicle;
check whether it is possible, proceeding from the rough position, to determine a precise position as a function of the operating state; and
determine the precise position when it is possible to determine the precise position, or provide a signal, which represents a non-determination of the precise position, when it is not possible to determine the precise position; and
operate the vehicle, as a function of the precise position or as a function of the signal.

15. A non-transitory machine-readable memory medium on which is stored a computer program for operating an automated vehicle, the computer program, when executed by a computer, causing the computer to perform the following steps:
determining a rough position;
detecting an operating state of the automated vehicle;
checking whether it is possible, proceeding from the rough position, to determine a precise position as a function of the operating state; and
determining the precise position when it is possible to determine the precise position, or providing a signal, which represents a non-determination of the precise position, when it is not possible to determine the precise position; and
operating the vehicle, as a function of the precise position or as a function of the signal.
